(19) United States
(12) Patent Application Publication
(10) Pub. No.: US 2025/0161988 A1
(43) Pub. Date: May 22, 2025

(54) SYSTEMS, DEVICES AND METHODS FOR SCREENING INDUSTRIAL PRODUCTS

(71) Applicant: SUNCOKE TECHNOLOGY AND DEVELOPMENT LLC, Lisle, IL (US)

(72) Inventor: John Francis QUANCI, Haddonfield, NJ (US)

(21) Appl. No.: 18/954,859

(22) Filed: Nov. 21, 2024

Related U.S. Application Data
(60) Provisional application No. 63/601,421, filed on Nov. 21, 2023.

(51) Int. Cl. B07B 1/12

(52) U.S. Cl. CPC B07B 1/12

(57) ABSTRACT

Systems, devices and methods for screening materials or industrial products, such as foundry coke, are disclosed herein. In some embodiments, representative systems and/or devices can include (i) a plurality of screening members each extending along a first axis, wherein the screening members are configured to make contact with a material to be screened, (ii) a plurality of elevating members extending along the first axis, wherein individual elevating member are coupled to a lower portion of corresponding individual screening members, and (iii) a cross support extending along a second axis angled relative to the first axis, wherein the cross support is coupled to a lower portion of at least some of the elevating members.

### CROSS-REFERENCE TO RELATED APPLICATION(S)

The present application claims the benefit of U.S. Provisional Patent Application No. 63/601,421, filed Nov. 21, 2023, the disclosure of which is incorporated herein by reference in its entirety.

### TECHNICAL FIELD

This present disclosure relates to systems, devices and methods for screening industrial products. Some embodiments relate to systems, devices and methods for screening coke products.

### BACKGROUND

Coke is a solid carbon fuel and carbon source used to melt and reduce iron ore in the production of steel. To make coke, finely crushed coal is fed into a coke oven and heated in an oxygen-depleted environment under closely controlled atmospheric conditions. Such an environment drives off volatile compounds in the coal, leaving behind coke. In some coking plants, once the coal is “coked out” or fully coked, an oven door is opened and the hot coke is transported from the coke oven to a quenching area (e.g., wet or dry quenching) to cool the coke below its ignition temperature. After being quenched, the coke is screened (e.g., based on size) and loaded into rail cars or trucks for shipment or later use.

The size of the coke used in foundry cupolas has an impact on the heating value of the process. Generally, coke with a large size and a uniform size distribution is desirable for a more controlled heating. Avoiding excessive degradation in size is also desirable. Coke may also get stuck in a screener during the screening process, resulting in a reduction in the amount of screened coke and interference with subsequent screening. Therefore, there is a need for a screener that can consistently screen materials, such as coke products, based on a desired size threshold without becoming stuck in the screener.

### BRIEF DESCRIPTION OF THE DRAWINGS

Features, aspects, and advantages of the presently disclosed technology may be better understood with regard to the following drawings.

FIG. 1A is a perspective view of a screener in accordance with embodiments of the present technology.

FIG. 1B is a side view of the screener of FIG. 1A.

FIG. 1C is a front view of the screener of FIG. 1A.

FIG. 1D is a top-down view of the screener of FIG. 1A.

FIG. 1E is a bottom-up view of the screener of FIG. 1A.

FIG. 2 is a simplified plan view of screening elements in accordance with embodiments of the present technology.

FIG. 3 is a side view of a screener in accordance with embodiments of the present technology.

FIG. 4 is a bottom-up view of a screener in accordance with embodiments of the present technology.

FIG. 5 is a side view of a screener in accordance with embodiments of the present technology.

FIG. 6 is a front view of a screener in accordance with embodiments of the present technology.

FIG. 7 is a flow diagram illustrating a method of screening materials in accordance with embodiments of the present technology.

FIG. 8 is a side view of a screener mounted on an end of a loading belt in accordance with embodiments of the present technology.

FIG. 9 is an enlarged side view of a screener mounted on an end of a loading belt in accordance with embodiments of the present technology.

FIG. 10 is an enlarged bottom-up view of a screener mounted on an end of a loading belt in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present disclosure relate to systems and methods for screening industrial products, such as coke, foundry coke, and/or granulated pig iron. The coking process produces coke products of various sizes in different fractions. Conventionally, the coke products are classified based on size, with foundry coke having a size of 4″+, egg (industrial coke) having a size of 2-4″, stove having a size of 1-2″ or 1-1.5″, nut having a size of 0.5-1″, and breeze having a size<0.5″. After production, the coke products are screened, e.g., to separate the foundry coke and egg, from the other products of the batch. However, filtering just certain products (e.g., the foundry coke and/or egg) can be difficult, as the shape and size of the overall production can cause plugging. For example, using a large perforated screen or slotted plates results in plugging which inhibits or prevents effective filtering of the smaller products. Embodiments of the present disclosure address at least some of the above-described issues, and include (i) a screener apparatus comprising a screening member extending along a first axis, wherein the screening member is configured to make contact with a material to be screened, (ii) an elevating member extending along the first axis, wherein the elevating member is coupled to a lower portion of the screening member, and (iii) a cross support extending along a second axis angled relative to the first axis, wherein the cross support is coupled to a lower portion of the elevating member.

Additionally or alternatively, embodiments of the present disclosure can also include a device for screening materials. The device can comprise a filtering device comprising a plurality of screening elements and a cross support coupled to the plurality of screening elements, wherein each of the plurality of screening elements includes a first portion and a second portion coupled to a lower region of the first portion, wherein the first portion has a first cross-sectional dimension and the second portion has a second cross-sectional dimension less than the first cross-sectional dimension, and wherein each of the plurality of screening elements is spaced apart from an adjacent screening element by a distance of, for example, at least 0.5 inch.

Embodiments of the present disclosure also include a method of screening a material, comprising providing a filtering device including a plurality of screening elements and a cross support coupled to the plurality of screening elements, wherein each of the plurality of screening elements includes a first portion and a second portion coupled to a lower region of the first portion, wherein the first portion has a first cross-sectional dimension and the second portion has a second cross-sectional dimension less than the first cross-sectional dimension, and wherein each of the plurality of screening elements is spaced apart from an adjacent screening element by a distance of, for example, at least 0.5 inch, and contacting the plurality of screening elements with the material.

Embodiments of the present disclosure enable industry products, such as foundry coke, being screened to slide across a plurality of screening elements of a screener at least in part due to gravity (e.g., by being positioned at an angle). The plurality of screening elements are configured (e.g., sized and spaced apart from one another) such that industrial products below a certain size drop in between the screening elements, while other industrial products that do not drop slide to an end portion of the screener and are transported for further processing and/or use (e.g., via a belt). A first portion of each of the plurality of screening elements that contacts the industrial products is separated and/or elevated from one or more cross support members of the screener by a second portion of each of the plurality of screening elements (e.g., that does not contact the industrial products), such that the industrial products do not become stuck while traveling across the screener. The second portions of the screening elements are separated by a lateral distance greater than the lateral distance separating the first portions of the screening elements such that only the first portions affect the size threshold for screening.

In the Figures, identical or similar reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Systems, Device and Methods for Screening Industrial Products

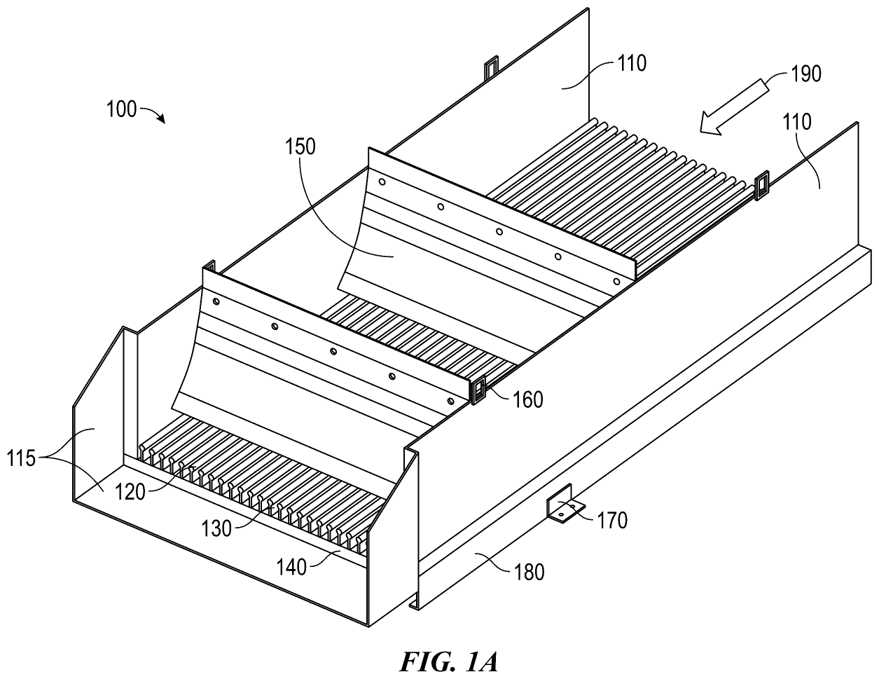

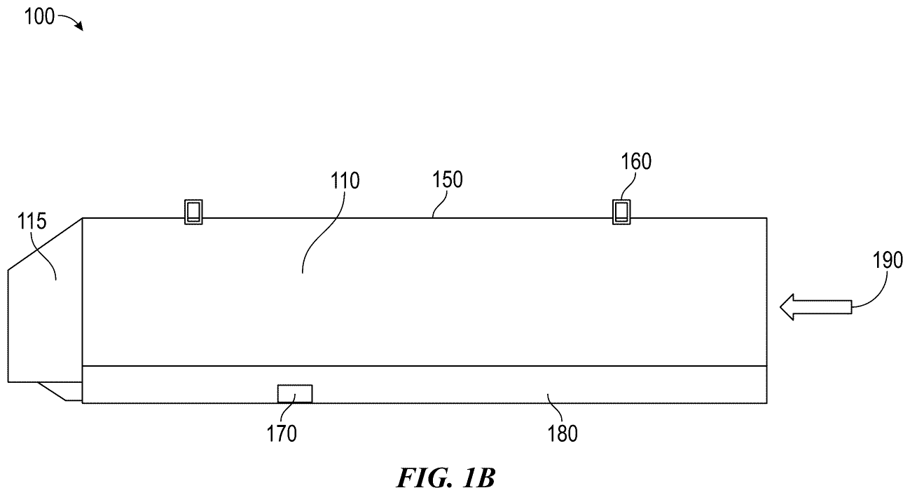

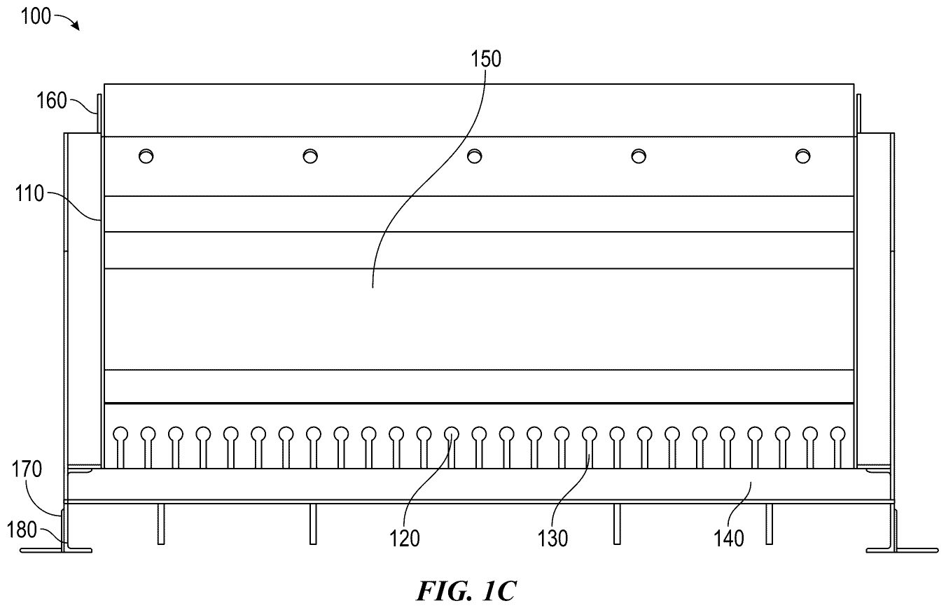

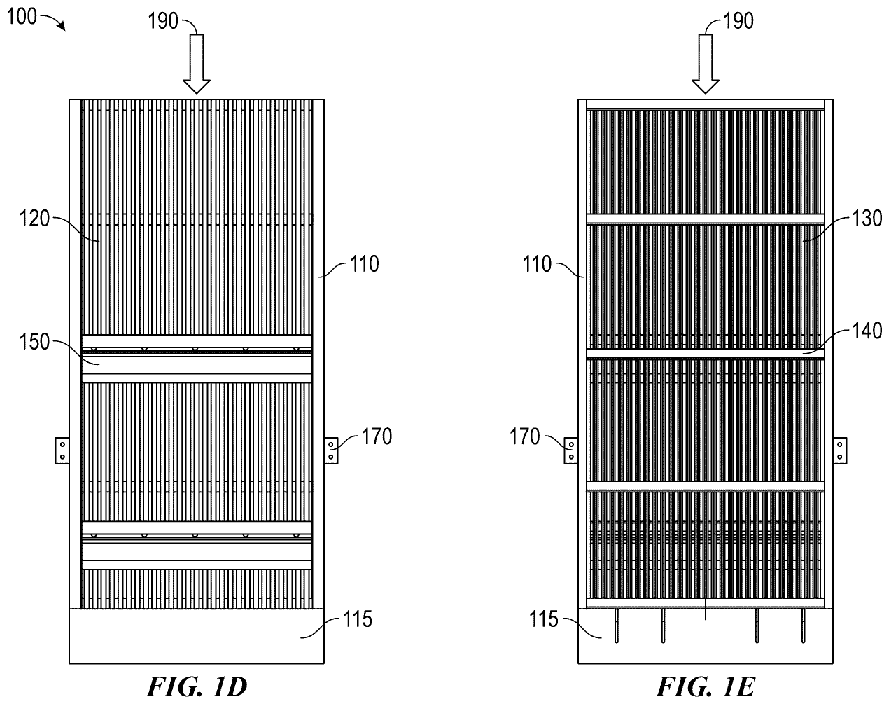

FIGS. 1A, 1B, 1C, 1D, and 1E are perspective, side, front, top-down, and bottom-up views, respectively, of a screener apparatus (and/or device) 100, in accordance with embodiments of the present technology. Referring to FIGS. 1A-1E together, the screener apparatus 100 has a plurality of screening elements 102, each of which includes a screening member (e.g., first portion) 120 and an elevating member (e.g., second portion) 130 coupled to and/or extending from a lower portion and/or region of the screening member 120. The screening member 120 and elevating member 130 can comprise a continuous surface and be a single contiguous structure. The screener apparatus 100 also has one or more cross supports 140 coupled to a lower portion and/or region of the elevating member 130. Coupling the elevating member 130 to the lower portion of the one or more cross supports 140, as opposed to a side portion of the elevating member 130 or screening member 120, can advantageously ensure that the cross supports 140 do not provide an area for the industrial products to become plugged. The screening members 120 and the elevating members 130 extend along a first axis, and the cross supports 140 extend along a second axis angled (e.g., perpendicular, 45 degrees, 60 degrees) relative to the first axis, as seen in FIG. 1E.

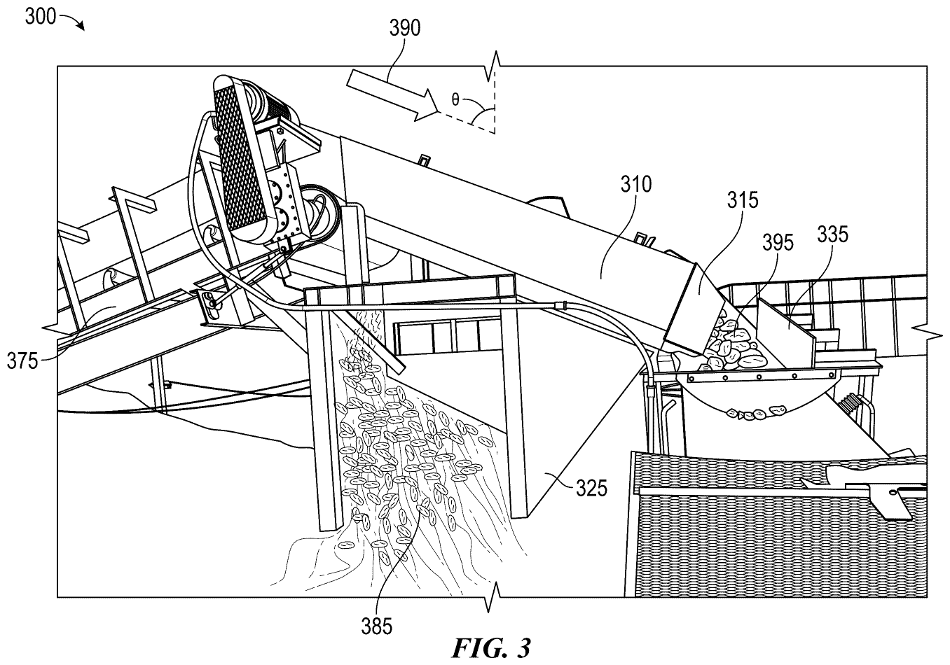

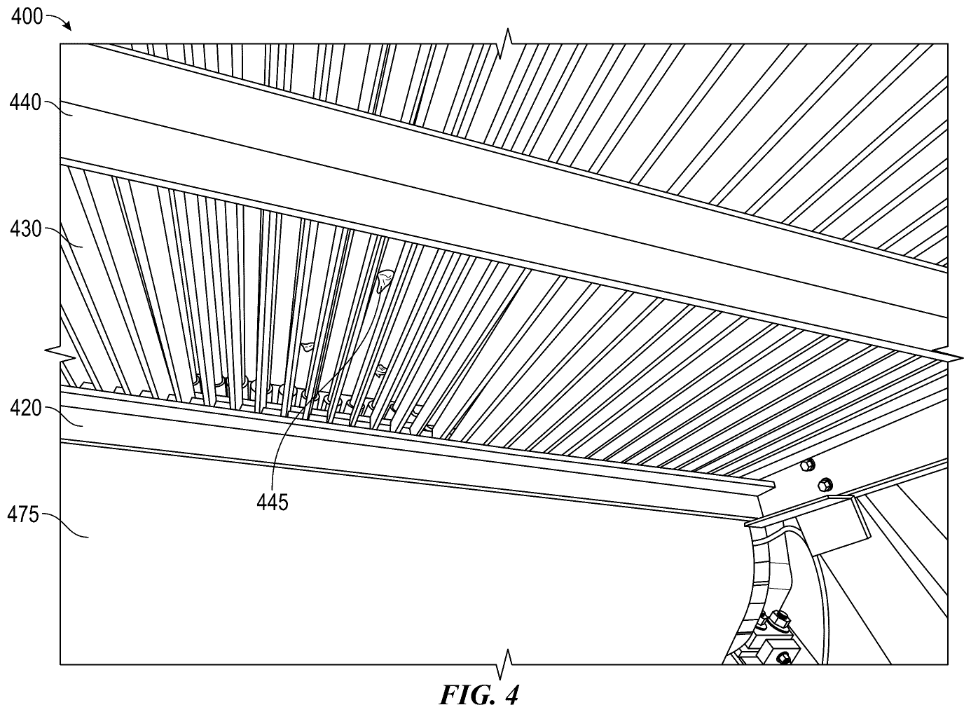

The screener apparatus 100 includes two side wall portions 110 that extend generally along the first axis on either side of the plurality of screening elements 102. Lift brackets 160, which assist in transporting the screener apparatus 100, are coupled to upper portions of the side wall portions 110. One or more flaps 150 are coupled to the side wall portions 110 such that the flaps 150 are disposed over the plurality of screening elements 102. The flaps 150 can have shapes different from the illustrated embodiment. Side guides 180 are further coupled to the side wall portions 110. Connecting brackets 170 are configured to fixedly attach the side guides 180 to a support structure (illustrated in FIG. 3) such that the screener apparatus 100 can be positioned or orientated in a desired manner. The screener apparatus 100 further comprises outlet guides 115 configured to receive the screened material and/or guide the screened material to another equipment (e.g., a belt for transporting coke).

In operation, foundry coke, for example, is transported (e.g., after being quenched) onto the screener apparatus 100 in any direction, including a travel direction 190 (e.g., manually, via a belt). The travel direction is parallel to or generally aligned with the first axis in which the plurality of screening elements 102 extend. The screener apparatus 100 can be angled relative to a direction of gravity by, for example, 10-80 degrees, to cause the foundry coke to slide down the screening members 120 at least in part due to gravity. The screener apparatus 100 can also be vibrated to facilitate sliding of the foundry coke atop the screening members 120. The side wall portions 110 keep the foundry coke within the screener apparatus 100, and the flaps 150 decrease a velocity of the foundry coke, thereby improving the screening ability of the screener apparatus 100. As the foundry coke slides down the length of the screener apparatus 100 in the travel direction 190, some products (e.g., stove, nut, breeze, etc.) that are small enough fall down in between the screening members 120 and past the elevating members 130 and the cross supports 140 to a disposal area (e.g., on the ground, a collection vessel, etc.). The remaining products (e.g., foundry coke, egg, etc.) that did not fall through exit the screener apparatus 100 via the outlet guides 115 to be transported for further processing and/or use (e.g., via a belt).

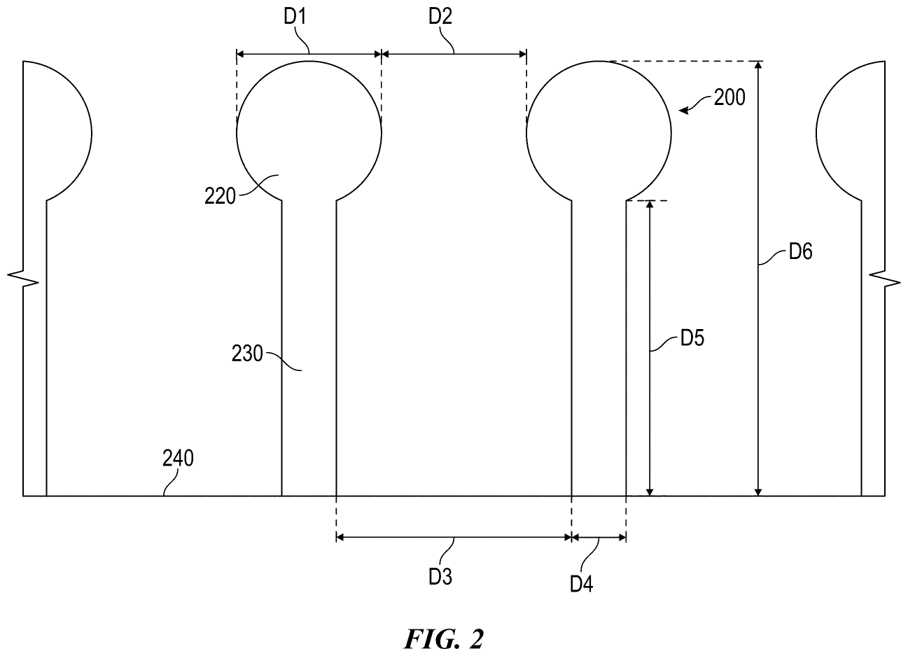

FIG. 2 is a plan view of a plurality of the screening elements 102 referred to in FIGS. 1A-1E, in accordance with embodiments of the present technology. As shown in FIG. 2, the plurality of screening elements 102 sit atop the one or more cross supports 140. As previously described, each of the screening elements 102 includes the screening member 120 and the elevating member 130 coupled to a lower portion of the screening member 120. In the illustrated embodiment, the screening member 120 is a rod with a circular cross-section and/or curved outer surface, and the elevating member 130 is a bar with a rectangular cross-section. The circular cross-section and/or curved outer surface of the screening member 120, in combination with other features of the screening apparatus 100 (FIGS. 1A-1E), can help inhibit or prevent plugging of the areas between the screening elements 102 with industrial product. In some embodiments, the screening member 120 and the elevating member 130 have other cross-sections and/or shapes (e.g., an inverted triangle with a flat portion positioned to contact the industrial product). The elevating member 130 can be coupled to the screening member 120 via fasteners and/or welding. The screening member 120 can be fixedly coupled to the elevating member 130 along an entire length of the screening member 120.

The screening member 120 has a first cross-sectional dimension (e.g., diameter) D1. Each of the screening members 120 is spaced apart from an adjacent screening member 120 by a screening distance D2. The elevating member 103 has a second cross-sectional dimension (e.g., thickness) D4 smaller than the first cross-sectional dimension D1. Each elevating member 130 is spaced apart from an adjacent elevating member 130 by an elevating member separation distance D3.

In operation, the industrial products are screened (e.g., by size and/or shape) such that small enough products fall in between individual screening elements 102. The first cross-sectional dimension D1 and the screening distance D2 can be determined based on the desired threshold screening size of the industrial products. For example, the first cross-sectional dimension D1 can be at least 0.5 inch, 1.0 inch, 1.5 inches, or 0.5-1.5 inches and the screening distance D2 can be at least 0.1 inch, 0.5 inch, 1.0 inch, 1.5 inches, 2.0 inches, or 0.1-2 inches. Any combination of the first cross-sectional dimension D1 and the screening distance D2 can be used.

The second cross-sectional dimension (e.g., thickness) D4 is less than the first cross-sectional dimension D1 (i.e., the elevating member separation distance D3 is greater than the screening distance D2) such that the elevating members 130 do not affect the screening size threshold. In other words, although some industrial products may contact the elevating members 130 while falling, the elevating members 130 are configured not to impact whether the industrial product falls or not. The second cross-sectional dimension D4 can be at least 0.25 inch, 0.375 inch, 0.5 inch, 0.625 inch, 0.75 inch, 1.0 inch, or 0.25-1.0 inch.

The elevating member 130 is configured to separate (e.g., elevate) the screening member 120 from the cross supports 140 by a third cross-sectional dimension (e.g., height) D5. The third cross-sectional dimension D5 can be at least 1.0 inch, 2.0 inches, 3.0 inches, or 1.0-3.0 inches. Once the elevating member 130 is coupled to the screening member 120, each screening element 102 has a screening height D6.

The screening elements 102 provide several advantages. For example, the circular cross-section of the screening member 120 allows the industrial products to travel generally between two adjacent screening members 120 as opposed to travelling atop a single screening member 120 or a perforated plate that can trap material on its ridges. This ensures that small enough industrial products do fall and the industrial products are screened properly. The rectangular cross-section of the elevating member 130 allows separation of the screening member 120 and the cross supports by any predetermined distance (i.e., the third cross-sectional dimension D5) without having the elevating member 130 interfere with the screening. The separation prevents the cross supports 140 from interfering with the industrial products traveling atop the screening members 120. Without sufficient separation, industrial products may become stuck due to the cross supports 140. Moreover, the cross-sections of the screening member 120 and the elevating member 130 allow case of manufacturing (e.g., using metal such as stainless steel). The screening members 120, the elevating members 130, and the cross supports 140 can also be coupled via fasteners and/or welding. Furthermore, the screening distance D2 can be easily fixed or adjusted based on evolving screening needs.

FIG. 3 is a side view of a screener apparatus 300, in accordance with embodiments of the present technology. The screener apparatus 300 can correspond to the screener apparatus 100 described with reference to FIGS. 1A-2. The screener apparatus 300 is supported by a support structure 325 and industrial products are transported onto the screener apparatus 300 by a loading belt 375. The industrial products travel through the screener apparatus 300 in a travel direction 390 that is at a screener angle θ relative to a direction of gravity. The screener angle θ can be at least 30 degrees, 40 degrees, 50 degrees, 60 degrees, 70 degrees, 80 degrees, or 30-80 degrees, which allows the industrial products to slide through the screener apparatus 300 solely or at least in part due to gravity. The screener apparatus 300 can also be vibrated to facilitate sliding of the industrial products.

As the industrial products are screened, and contained by side wall portions 310 (e.g., the side wall portions 110; FIGS. 1A-1E), insufficiently large industrial products 385 fall through into a disposal area defined by the support structure 325. Sufficiently large industrial products travel to the other end of the screener apparatus 300 and are guided by outlet guides 315 (e.g., the outlet guides 115; FIGS. 1A-1E) onto a transport belt 395 for further processing and/or use. A side plate 335 is positioned proximate to the transport belt 395 to prevent industrial products coming out of the screener apparatus 300 from falling beyond the transport belt 395. Flaps (not shown in FIG. 3) are configured to decrease a velocity of the industrial products such that the screened industrial products do not break up into smaller pieces upon hitting the side plate 335.

FIG. 4 is a bottom-up view of the screener apparatus 300, in accordance with embodiments of the present technology. Once industrial products are loaded onto the screening elements 302 (e.g., the screening elements 102; FIGS. 1A-2) of the screener apparatus 300 by a loading belt 375, the industrial products travel atop screening members 320 (e.g., the screening members 120; FIGS. 1A-2), which are separated from cross supports 340 (e.g., the cross supports 140; FIGS. 1A-2) by elevating members 330 (e.g., the elevating members 130; FIGS. 1A-2) to avoid having industrial products get stuck and cause backup. Sufficiently large industrial products 345 travel between individual screening members 320, but do not fall through.

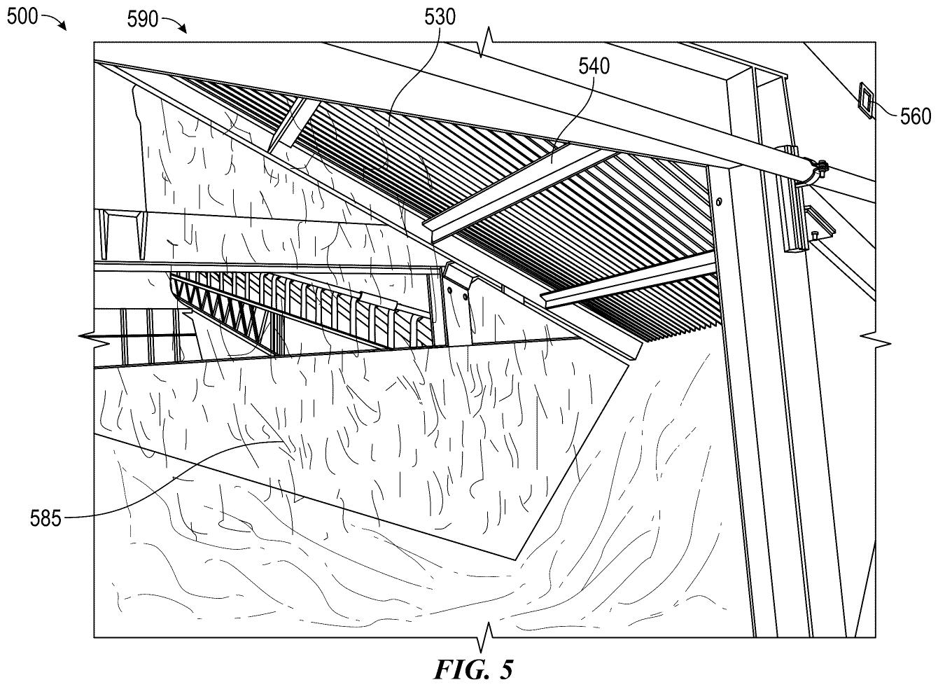

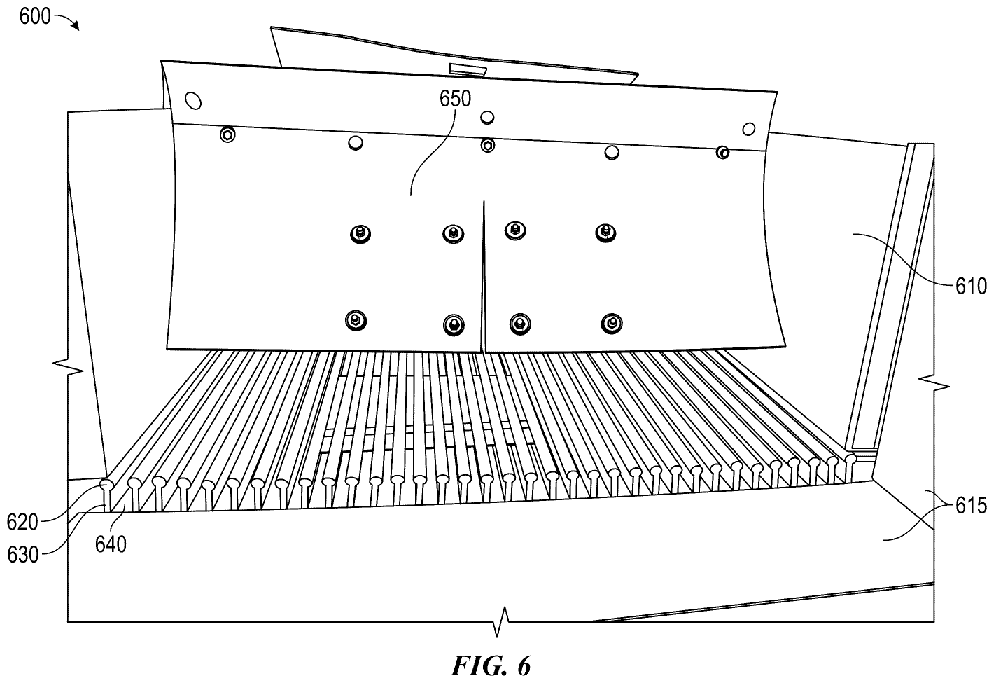

FIG. 5 is a side view of the screener apparatus 300, in accordance with embodiments of the present technology. Industrial products travel atop screening members (not shown in FIG. 5) and elevating members 330, which are supported by cross supports 340. As the industrial products travel in the travel direction 390, insufficiently large industrial products 385 fall through to a disposal area. The screener apparatus 300 includes one or more lift brackets 360 (e.g., the lift brackets 160; FIGS. 1A-1E) configured to assist in transporting the screener apparatus 300.

FIG. 6 is a front view of a screener apparatus 300, in accordance with embodiments of the present technology. Screening members 320 are rods with circular cross-sections, and are welded to elevating members 330, which are bars with rectangular cross-sections. The elevating members 330 are welded to one or more cross supports 340, which extend from one side wall portion 310 to another in a direction generally perpendicular to the direction in which the screening members 320 and elevating members 330 extend. In some embodiments, the screening members 320, the elevating members 330, and the cross supports 340 are coupled to one another via other means (e.g., fasteners).

The screener apparatus 300 can include one or more flaps 350 (e.g., the flaps 150; FIGS. 1A-1E) disposed over the screening elements 302. The flaps 350 can be made of metal and/or rubber, and are configured to decrease a velocity of the industrial products such that the screened industrial products do not break up into smaller pieces upon exiting the screener apparatus 300 via outlet guides 315 and hitting the side plate 335 (shown in FIG. 3). In the illustrated embodiment, each of the flaps 350 is coupled to a flap bar coupled to the side wall portions 310.

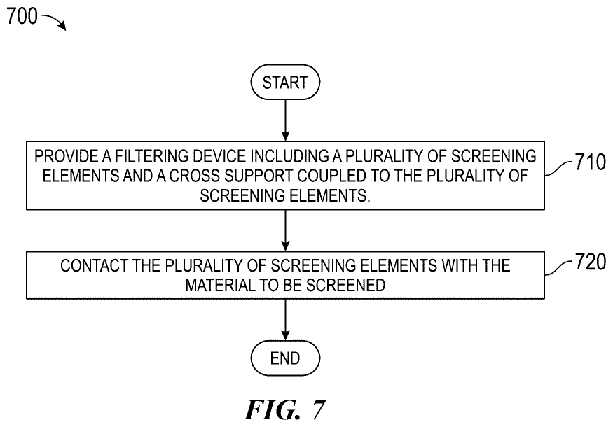

FIG. 7 is a flow diagram illustrating a method 700 of screening materials in accordance with embodiments of the present technology. The method comprises providing a filtering device (e.g., the screening apparatus 100, 300) including a plurality of screening elements (e.g., the screening elements 102, 302) and a cross support (e.g., the cross support 140, 340) coupled to at least some of the plurality of screening elements (process portion 710). Each of the plurality of screening elements includes a first portion (e.g., the screening member 120, 320) and a second portion (e.g., the elevating member 130, 330) coupled to a lower region of the first portion. The first portion has a first cross-sectional dimension (e.g., the first cross-sectional dimension D1), and the second portion has a second cross-sectional dimension (e.g., the second cross-sectional dimension D4) less than the first cross-sectional dimension. Each of the plurality of screening elements is spaced apart from an adjacent screening element by a distance of, for example, at least 0.5 inch.

The method 700 further comprises contacting the plurality of screening elements with the material (e.g., industrial products, foundry coke, etc.) to be screened (process portion 720). In some embodiments, a loading belt is used to transport the material to be screened onto the plurality of screening elements.

In some embodiments, the method 700 includes additional steps not illustrated in FIG. 7. The additional steps may come before, after, or between process portions 710 and 720. In some embodiments, the method 700 may further include angling the plurality of screening elements perpendicular to the cross support and/or at an angle (e.g., between 30-80 degrees) relative to a direction of gravity. In some embodiments, the method 700 may further include sliding the material over the plurality of screening elements such that a portion of the material falls in between individual screening elements.

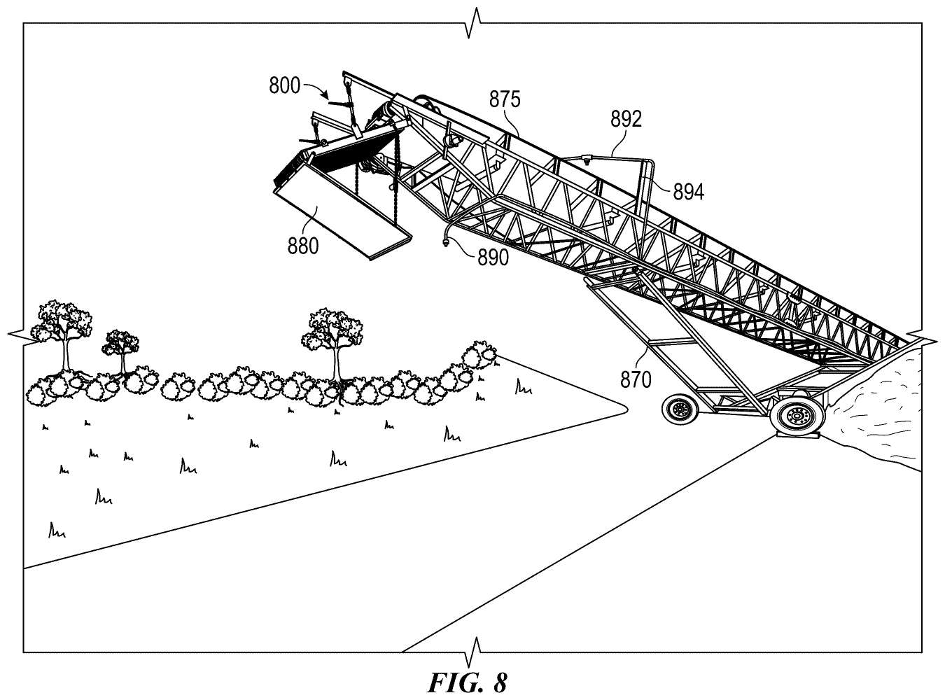

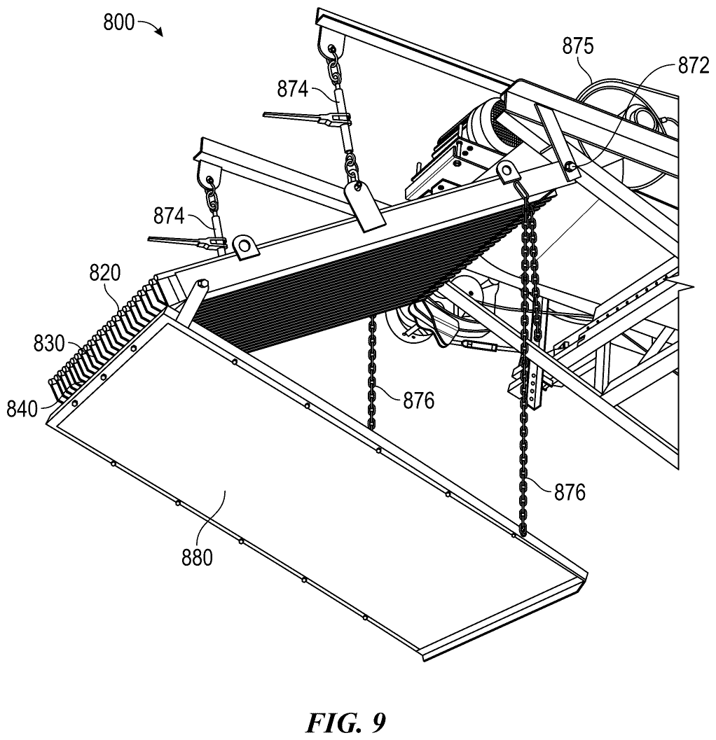

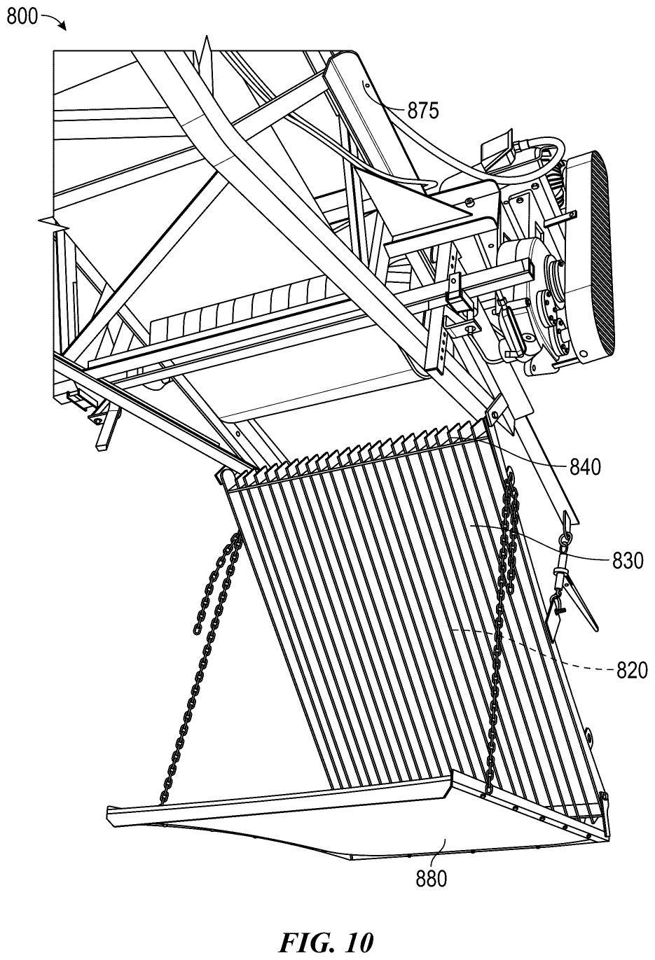

FIG. 8 is a side view of a screener apparatus 800 mounted on an end of a loading belt 875, in accordance with embodiments of the present technology. FIG. 9 is an enlarged side view of the screener apparatus 800, in accordance with embodiments of the present technology. FIG. 10 is an enlarged bottom-up view of the screener apparatus 800 mounted on an of a belt in accordance with embodiments of the present technology.

Referring to FIGS. 8-10 together, the screener apparatus 800 can correspond to the screener apparatus 100 described with reference to FIGS. 1A-2. The loading belt 875 can correspond to the loading belt 375 described with reference to FIGS. 3-6. By using the screener apparatus 800 and the loading belt 875, industrial products (e.g., coke or foundry coke) can be screened by size and loaded onto various vehicles or facilities for use or further processing. For example, products in a railcar (not shown) can be loaded onto the belt 875, dropped onto and screened via the screener apparatus 800, and dropped onto a loading truck (not shown).

The screener apparatus 800 is coupled to a pivot point 872 proximate to the end of the loading belt 875, which is lifted at an angle by a belt transporter 870. The screener apparatus 800 can be oriented at an angle relative to the belt 875 by adjusting connectors (e.g., chains) 874. The screener apparatus 800 includes screening members 820 (e.g., the screening members 120; FIGS. 1A-2), which are separated from cross supports 840 (e.g., the cross supports 140; FIGS. 1A-2) by elevating members 830 (e.g., the elevating members 130; FIGS. 1A-2) to avoid having industrial products get stuck and cause backup. Sufficiently large industrial products reach the end of the screener apparatus 800 without falling through, and can be dropped into, for example, a loading truck.

Small industrial products fall through the screening members 820 and hit a waste shield 880. The waste shield 880 is configured to direct small industrial products that fell through away from, for example, a loading truck and toward a waste pile on, for example, the ground. The waste shield 880 can be oriented at an angle relative to the screener apparatus 800 by adjusting connectors (e.g., chains) 876.

Referring now to FIG. 8, a first pipe 890, a second pipe 894, and a support member 898 are coupled to the loading belt 875. The first pipe 890 can extend along the length of the loading belt 875 and include a first spray nozzle 892 coupled to a distal end of the first pipe 890 that extends generally downward. The first pipe 890 can be secured to the loading belt 875 using clamps or other fastening mechanisms. The second pipe 894 can extend over the loading belt 875 and include one or more second spray nozzles 896 directed toward the loading belt 875. The support member 898 provides support to and suspends the second pipe 894 over the loading belt 875. In some embodiments, the first and second pipes 894 are fluidly coupled. In other embodiments, the first and second pipes 894 are not fluidly coupled and receive fluid from separate sources.

During operation, the first and second pipes 890, 894 can be configured to carry fluid towards the first and second spray nozzles 892, 896, respectively. The first and second spray nozzles 892, 896 can be controlled to release and spray the fluid. The fluid carried through the first and second pipes 890, 894 can be the same type of fluid or different types of fluid. For example, the first spray nozzle 892 can be directed downward towards a railcar (not shown) to coat the walls of the railcar. The fluid can be selected to reduce or prevent sticking of coke products with the walls of the railcar (e.g., a deicing fluid). In some embodiments, the railcar is slowly moved relative to the loading belt 875 such that all or a large portion of the railcar walls can be coated with the fluid while the first spray nozzle 892 remains stationary relative to the loading belt.

In another example, the second spray nozzle 892 can be directed downward towards coke products being transported on the loading belt 875. The fluid can be selected to reduce or prevent the coke products from freezing or otherwise sticking together (e.g., a deicing fluid). In the illustrated embodiment, the second pipe 894 is positioned at a generally intermediate position along the length of the loading belt 875. In other embodiments, the second pipe 894 is positioned elsewhere along the length of the loading belt 875, such as at the end of the loading belt 875 proximate the screener apparatus 800 such that the fluid is sprayed onto the coke products as they come off of the loading belt 875.

### IV. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses (1, 2, 3, etc.) for convenience. These are provided as examples and do not limit the present technology. It is noted that any of the dependent clauses may be combined in any combination, and placed into a respective independent clause. The other clauses can be presented in a similar manner.

1. A screener apparatus, comprising:
a screening member extending along a first axis, wherein the screening member is positioned to make contact with a material to be screened;
an elevating member extending along the first axis, wherein the elevating member is coupled to a lower portion of the screening member; and
a cross support extending along a second axis angled relative to the first axis, wherein the cross support is coupled to a lower portion of the elevating member.

2. The apparatus of any one of the clauses herein, wherein the screening member is a first screening member, and wherein the screener apparatus further comprises a second screening member spaced apart from the first screening member by a first distance of at least 0.1 inch and/or no more than 2 inches.

3. The apparatus of claim 2, wherein the elevating member is a first elevating member, and wherein the screener apparatus further comprises a second elevating member spaced apart from the first elevating member by a second distance that is greater than the first distance.

4. The apparatus of any one of the clauses herein, wherein the screening member comprises a rod with a circular cross-sectional area and the elevating member has a non-circular cross-sectional area.

5. The apparatus of any one of the clauses herein, wherein the screening member comprises a circular or spherical shape, an ovular shape, or a triangular shape.

6. The apparatus of any one of the clauses herein, wherein the screening member comprises stainless steel and/or a smooth surface.

7. The apparatus of any one of the clauses herein, wherein a cross-sectional dimension of the screening member is 0.5-1.5 inches.

8. The apparatus of any one of the clauses herein, wherein a cross-sectional dimension of the elevating member is less than a cross-sectional dimension of the screening member.

9. The apparatus of any one of the clauses herein, wherein the first axis is perpendicular to the second axis, and wherein the screening member and the elevating member are disposed at an angle of at least 10 degrees relative to a direction of gravity.

10. The apparatus of any one of the clauses herein, further comprising a first side wall and a second side wall, wherein the cross support extends from the first side wall to the second side wall.

11. The apparatus of any one of the clauses herein, further comprising a flap disposed over the screening member and configured to decrease a velocity of the material to be screened when traveling over the screening member.

12. The apparatus of any one of the clauses herein, wherein the screening member is one of a plurality of screening members and the elevating member is one of a plurality of elevating members.

13. The screener apparatus of any one of the clauses herein, wherein the elevating member is coupled to the lower portion of the screening member via fasteners and/or welding, and/or the cross support is coupled to the lower portion of the elevating member via fasteners and/or welding.

14. The apparatus of any one of the clauses herein, wherein the elevating member is fixedly coupled to the screening member along an entire length of the screening member.

15. A device for screening industrial products, comprising:
a filtering device comprising a plurality of screening elements and a cross support coupled to at least some of the plurality of screening elements, wherein:
   each of the plurality of screening elements includes a first portion and a second portion coupled to a lower region of the first portion,
   the first portion has a first cross-sectional dimension and the second portion has a second cross-sectional dimension less than the first cross-sectional dimension, and
   each of the plurality of screening elements is spaced apart from an adjacent screening element by at least 0.1 inch or 0.5 inch.

16. The device of any one of the clauses herein, wherein each of the first portions of the plurality of screening elements is spaced apart from an adjacent first portion by a first distance, and wherein each of the second portions of the plurality of screening elements is spaced apart from an adjacent second portion by a second distance greater than the first distance.

17. The device of any one of the clauses herein, wherein the plurality of screening elements is disposed at an angle of 30-80 degrees relative to a direction of gravity such that the industrial products travel over the plurality of screening elements due to gravity.

18. The device of any one of the clauses herein, wherein the plurality of screening elements is configured to allow a portion of the industrial products to fall in between individual screening elements when traveling over the plurality of screening elements.

19. The device of any one of the clauses herein, wherein the second portion is configured to separate the first portion and the cross support by a distance of at least 1 inch such that the materials traveling over the plurality of screening elements do not contact the cross support.

20. A method of screening a material, comprising:
providing a filtering device including a plurality of screening elements and a cross support coupled to at least some of the plurality of screening elements, wherein each of the plurality of screening elements includes a first portion and a second portion coupled to a lower region of the first portion, wherein the first portion has a first cross-sectional dimension and the second portion has a second cross-sectional dimension less than the first cross-sectional dimension, and wherein each of the plurality of screening elements is spaced apart from an adjacent screening element by a distance of at least 0.1 inch or 0.5 inch; and
contacting the plurality of screening elements with the material.

21. The method of any one of the clauses herein, further comprising angling the plurality of screening elements perpendicular to the cross support and/or at an angle of at least 10 degrees relative to a direction of gravity.

22. The method of any one of the clauses herein, further comprising sliding the material over the plurality of screening elements such that a portion of the material falls in between individual screening elements.

We claim:

1. A screener apparatus, comprising:
a screening member extending along a first axis, wherein the screening member is positioned to make contact with a material to be screened;
an elevating member extending along the first axis, wherein the elevating member is coupled to a lower portion of the screening member; and
a cross support extending along a second axis angled relative to the first axis, wherein the cross support is coupled to a lower portion of the elevating member.

2. The apparatus of claim 1, wherein the screening member is a first screening member, and wherein the screener apparatus further comprises a second screening member spaced apart from the first screening member by a first distance of at least 0.1 inch and/or no more than 2 inches.

3. The apparatus of claim 2, wherein the elevating member is a first elevating member, and wherein the screener apparatus further comprises a second elevating member spaced apart from the first elevating member by a second distance that is greater than the first distance.

4. The apparatus of claim 1, wherein the screening member comprises a rod with a circular cross-sectional area and the elevating member has a non-circular cross-sectional area.

5. The apparatus of claim 1, wherein a cross-sectional dimension of the screening member is 0.5-1.5 inches.

6. The apparatus of claim 1, wherein a cross-sectional dimension of the elevating member is less than a cross-sectional dimension of the screening member.

7. The apparatus of claim 1, wherein the first axis is perpendicular to the second axis, and wherein the screening member and the elevating member are disposed at an angle of at least 10 degrees relative to a direction of gravity.

8. The apparatus of claim 1, further comprising a first side wall and a second side wall, wherein the cross support extends from the first side wall to the second side wall.

9. The apparatus of claim 1, further comprising a flap disposed over the screening member and configured to decrease a velocity of the material to be screened when traveling over the screening member.

10. The apparatus of claim 1, wherein the screening member is one of a plurality of screening members and the elevating member is one of a plurality of elevating members.

11. The screener apparatus of claim 1, wherein the elevating member is coupled to the lower portion of the screening member via fasteners and/or welding, and/or the cross support is coupled to the lower portion of the elevating member via fasteners and/or welding.

12. The apparatus of claim 1, wherein the elevating member is fixedly coupled to the screening member along an entire length of the screening member.

13. A device for screening industrial products, comprising:
a filtering device comprising a plurality of screening elements and a cross support coupled to at least some of the plurality of screening elements, wherein:
each of the plurality of screening elements includes a first portion and a second portion coupled to a lower region of the first portion,
the first portion has a first cross-sectional dimension and the second portion has a second cross-sectional dimension less than the first cross-sectional dimension, and
each of the plurality of screening elements is spaced apart from an adjacent screening element by at least 0.1 inch.

14. The device of claim 13, wherein each of the first portions of the plurality of screening elements is spaced apart from an adjacent first portion by a first distance, and wherein each of the second portions of the plurality of screening elements is spaced apart from an adjacent second portion by a second distance greater than the first distance.

15. The device of claim 13, wherein the plurality of screening elements is disposed at an angle of 30-80 degrees relative to a direction of gravity such that the industrial products travel over the plurality of screening elements due to gravity.

16. The device of claim 13, wherein the plurality of screening elements is configured to allow a portion of the industrial products to fall in between individual screening elements when traveling over the plurality of screening elements.

17. The device of claim 13, wherein the second portion is configured to separate the first portion and the cross support by a distance of at least 1 inch such that the industrial products traveling over the plurality of screening elements do not contact the cross support.

18. A method of screening a material, comprising:
providing a filtering device including a plurality of screening elements and a cross support coupled to at least some of the plurality of screening elements, wherein each of the plurality of screening elements includes a first portion and a second portion coupled to a lower region of the first portion, wherein the first portion has a first cross-sectional dimension and the second portion has a second cross-sectional dimension less than the first cross-sectional dimension, and wherein each of the plurality of screening elements is spaced apart from an adjacent screening element by a distance of at least 0.1 inch; and
contacting the plurality of screening elements with the material.

19. The method of claim 18, further comprising angling the plurality of screening elements perpendicular to the cross support and/or at an angle of 30-80 degrees relative to a direction of gravity.

20. The method of claim 18, further comprising sliding the material over the plurality of screening elements such that a portion of the material falls in between individual screening elements.
